(19) United States
(12) Patent Application Publication
(10) Pub. No.: US 2003/0170904 A1
(43) Pub. Date: Sep. 11, 2003

(54) Odour sensor

(76) Inventors: Brynn Hibbert, Sidney (AU); David Doran, Sydney (AU); Donald Barnett, Sydney (AU)

Correspondence Address: Morris Liss, Connolly Bove Lodge & Hutz, P O Box 19088, Washington, DC, 20036-3425, US

(21) Appl. No.: 10/343,940

(22) PCT Filed: Aug. 14, 2001
(86) PCT No.: PCT/AU01/01003

(30) Foreign Application Priority Data
Aug. 15, 2000 (AU) PQ 9371

(51) Int. Cl. G01N 21/64

(52) U.S. Cl. 436/128; 422/88; 436/172

(57) ABSTRACT

An odour sensor utilises an amine or an aldehyde dispersed in a polymer film to detect a vapour phase aldehyde or amine respectively. The amine and aldehyde react to form fluorescent reaction product which is detected by measuring the fluorescence emitted after irradiating the sensor element with UV light. The sensor contains a camera and a programmed cpu to analyse the fluorescence to determine the identity of the vapour phase molecule and its concentration.

This invention relates to sensors that detect odours particularly those that indicate loss of freshness in food.

### BACKGROUND TO THE INVENTION

Odours are often an early warning of deterioration in food quality but humans cannot smell all molecules at all concentration and only a few people have a highly developed and trained sense of smell.

Odour detection is also of use in controlling importation of prohibited substances such as drugs animal or vegetable substances and explosive devices. There is a demand for a sensor that can detect specific odour molecules and provide a quantitative measure of their presence at concentrations of 1 ppm or lower.

Most sensor systems are based on measuring changes in a physical property such as light emission or transmission. U.S. Pat. Nos. 5,298,741, 5,512,490, and 5,541,851, disclose an odour sensing system which utilises a polymer containing nile red a fluorescent dye. When polar molecules are absorbed into the polymer the polarity changes and this changes the fluorescent emission characteristics of nile red change and this is used to detect polar odour molecules. Small changes in fluorescence are measured but these changes require relatively large numbers of molecules to be absorbed into the polymer. It is difficult for this system to be sensitive to measure in parts per million or lower as is required in the food industry. The compounds detected as illustrated in the examples did not include the most common food odours indicative of loss of freshness.

It is an object of this invention to provide an odour detector suitable for the food industry and sensitive to molecules in concentrations at or below 1 ppm.

### BRIEF DESCRIPTIONS OF THE INVENTION

To this end the present invention provides a sensor film for use in a gas phase sensor which consists of an aldehyde or an amine dispersed in a polymeric film. Most odours indicative of loss of freshness are either amines or aldehydes. When amines react with aldehydes one of the reaction products formed is a fluorophore.

This invention is predicated on the discovery that a vapour state aldehyde or amine can react with an amine or aldehyde dispersed in a solid state film to form a fluorophore. In the prior art, sensors that rely on tracking a chemical reaction usually utilise a solution as the reaction media not a solid phase. Aldehyde/amine reactions in solution are optimised at a high pH which is difficult to duplicate in the solid state.

The sensor of this invention includes a light source for irradiating the sensor film at one or more predetermined frequencies to excite the fluorophore and a light detector for measuring the generated fluorescence at a second frequency. In contrast to the prior art which measures small changes in an established fluorescence source this invention measures changes from a state of zero fluorescence and thus provides a more sensitive system. The increasing fluorescence tracks the formation of a fluorescent reaction product between a molecule of an aldehyde or an amine in the vapour state and an amine or aldehyde respectively in the solid state, in the sensor film. The identity of the fluorescent reaction product is not known but it is suspected that the amine aldehyde addition product results in a carbon-carbon double bond conjugated with an imine and that it is the presence of this conjugation that provides the fluorescence.

Because the sensor of this invention tracks the concentration of chemical reaction product, the sensor tracks the reaction, over time, of a gaseous molecule. This enables the sensor to be used differently to prior art sensors which simply observe a physical reaction that may be reversible. By placing sensor films into food packages at the time of packing, the packages can be exposed to an appropriate light source and the presence of fluorescence indicates that some odour molecules are present. The intensity of the fluorescence is a measure of the total amount of deterioration that has occurred. In other situations the emission of odour molecules over a predetermined time period can be measured by replacing the sensor film after a predetermined interval and comparing the fluorescent intensity after each interval. In a preferred aspect this invention is concerned with the detection of rancidity in foodstuffs. Fats and fat containing food stuffs such a oats can exhibit rancidity if stored for long periods. Hexanal is a major component of the smell attributable to rancidity.

The wavelength of light used to radiate the film is preferably between 350 and 400 nm more preferably 370-390 nm. Depending on the molecule detected the fluorescence occurs at a longer wavelength usually 400 to 500 nm.

The sensor film may be any polymer capable of providing a suitable environment for reacting the amine and the aldehyde. A preferred polymer is one which is capable of forming a self assembled monolayer film. The sensor film needs to be compatible with the sensor compound. The polymer must be capable of dispersing the aldehyde or amine and not reacting with it. The film may be of conventional thickness ie a few 100's of micrometres thick.

The concentration of the amine or aldehyde in the sensor film may be up to 100% by weight of the film as in the case of a polymeric film of the sensor compound. Generally 1-10% by weight of the compound in the film is sufficient. At these concentrations the film can be exposed to 1 ppm concentrations of target molecule for long periods of time before the sensor films are saturated.

The sensor combination of UV light source, film and fluorescence detector may be used alone or in an array depending on the sensitivity desired. The fluorescence detector may be on the same side of the film as the light source if reflectance is relied on or it may be on the opposite side, if the film and its support is transparent to the frequencies being detected. Filters can be interposed between the film and the fluorescence detector to facilitate measurement.

### DETAILED DESCRIPTION OF THE INVENTION

Vapour Flow Through Sensor

The electronic sensing device has the following components

1. An air inlet and outlet

2. A sensor film disposed in a 3×3 array between the inlet and outlet so that vapour molecules can be absorbed into the sensor film and react with the target reactant to form a fluorescent molecule. The individual sensor elements in the array may be of different polymer sensing molecule combinations to discriminate among a mixture of odours or repeats of a single sensor film for a single odour. For detection of rancidity, where the presence of hexanal and other characteristic aldehydes is being detected, a single sensor film either repeated in the array or as a continuous film, is sufficient. The film is supported on a stainless steel substrate which enhances the fluorescence because it reflects light back through the film. Where sensitivity is not critical the backing may be transparent and this has the advantage that the instrument is easier to construct.

3. A source of radiated light generally 370-390 nm is used and filtered to narrow the bandwidth to that wavelength band. The light source is a 3×3 array of photo diodes with a primary emitting frequency in the ultra violet range. However any suitable ligt souce such as a filtered lamp will suffice.

4. A light detector located so that it receives negligible reflected light from the source and which has filters so that the majority of light received will be in a wavelength range of 440-465 nm at which the target molecules emit fluorescence. The light detector may be an array of photodiodes or a digital camera.

5. A programmable CPU, programmed with software that enables analysis of the light received and matches the emissions against a database of stored emissions.

6. The hue (H), hue saturation (S) and Luminance (L) of the received light is analysed so that the principal odour molecule and its concentration can be determined. The capture of the fluorescence can be a single image, intermittent or continuous. The frequency of interest can be processed to generate a histogram.

7. This histogram is then compared against a database of images and histograms through a pattern matching process. The hue, saturation and luminance values are compared with the values of a stored image. Threshold differences may be set to determine a match as can the particular measurand (H, S or L). The principles of such pattern matching software are well established.

Because the sensor measures a chemical reaction, the first readable fluorescence may not be observed for at least half an hour, particularly if the ambient temperature about the sensor element is below 40° C. The detection can be carried out at ambient temperature although temperatures up to 60° C. are preferred as the reaction proceeds faster at higher temperature. At temperatures above 60° C. there is a risk that the fluorescent compounds may start to decay.

The sensor element or film need not be located within the sensor itself but can be a component of packaging either as a tab attached to the packaging or forming part of the packaging wall material. The sensor is then arranged so that the sensor element can be irradiated and the fluorescence emitted measured to give an indication of the accumulated odour molecules emanating from the material in a package. This embodiment gives an indication of shelf life for the stored material.

Sensors can be permanently located in larger storage areas to measure the emission of odour molecules over time. By not changing the sensor element an accumulated reading is obtained until saturation is reached. Alternatively if a strip of sensor elements on a web are sequentially exposed for a predetermined interval and then subjected to a reading the change in odour molecule concentration and composition can be tracked over an extended period.

Aldehyde Detection

It is known that aldehydes are key components in the off odours associated with rancidity of various fat containing foods but also of a range of other odours that are characteristic.

| Odour | Aldehyde |
|---|---|
| green | Pentanal |
| Burnt, roasted | 2-pentanal |
| Oily, fatty | 2-heptanal |
| waxy | Benzaldehyde |
| orange | 3-Octadecanal |
| bitter | 2-ethyl butanal |
| Meaty, bacon | Tridecanal |
| Rancid oats | Hexanal, pentanal, 2-heptene-1-al, |
| | 2,4 nonadienal |
| Mushroom | 3-methylbutanal |

This invention is particularly concerned with detecting rancidity which is the result of the deterioration of fats in foodstuffs particularly cereals such as oats. Studies have shown that 80% of the variation in rancidity measurements is due to variation in the presence of hexanal.

This invention relies on the reaction with amines to form a fluorescent product. Any non fluorescent amine of the formula RCH₂NH₂ [Where R is hydrogen or an organic radical] can be used if it can be immobilised into a thin polymeric film that is capable of absorbing a vapour phase aldehyde.

Suitable amines include methylamine, propylamine, histamine, lysine and preferably, tyramine. Polyamines such as poly tyramine are also suitable. The polymer film may be any suitable film forming polymer and is preferably one which forms a self-assembled monolayer film. Suitable polymers include Polyvinyl chloride [PVC] or a co-polymer of methylmethacrylate and butylmethylacrylate [PMMBM].

As mentioned above a polymer film having pendant amine groups such as a poly tyramine are also suitable. Where the amine is water soluble (Lysine) a water soluble or dispersible polymer may be preferred.

### EXAMPLE 1

### Preparation of an Amine Sensor

Dissolve 0.2 g of PMMBM or 0.12 g of PVC in 3 mL of a 10 mM solution of tyramine in pure tetrahydrofuran as solvent

Add 0.2 mL of the plasticiser dibutylphthalate s

Drop about 0.5 mL of this solution onto a stainless steel base

Leave to dry preferably for 20 hours

The stainless steel base is preferred to other bases such as glass as it apparently enhances fluorescence. The concentration of amine in the polymer is about 2.5% or 10 mM

An optimum temperature for using the sensor is 56° C.

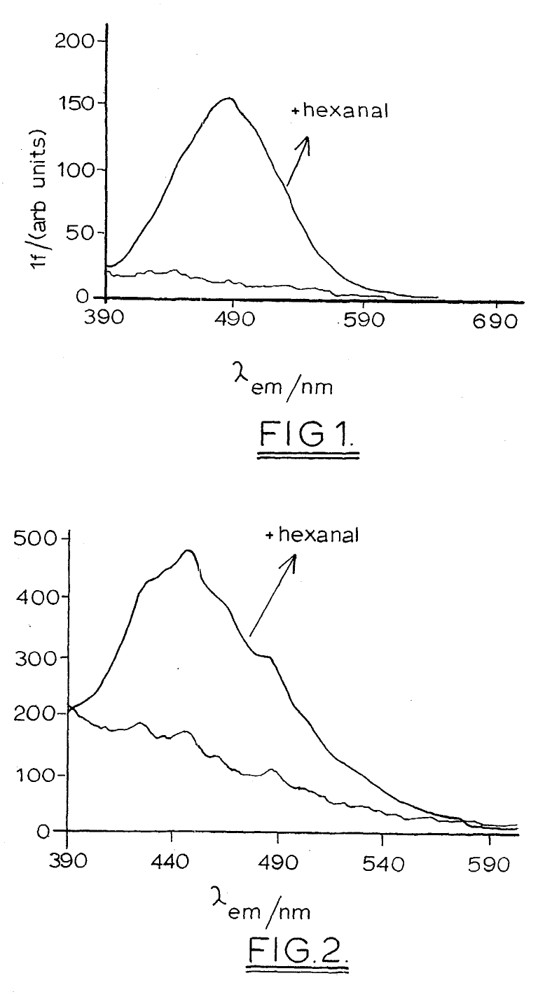

FIG. 1 illustrates the fluorescence measured from an air stream saturated with hexanal at room temperature using tyramine contained in a PVC sensor film. The control shown for comparison was an air stream with no hexanal.

FIG. 2 illustrates the fluorescence measured from an air stream with 0.7 ppm hexanal at 50° C. The sensor film is tyramine in a FPABS film. The control was an air stream with no added hexanal. This indicates that hexanal at concentrations of 0.7 ppm is detectable.

Amine Detection

Amines are usually associated with putrefying animal, fish, and vegetable materials.

| Odour | AMINE |
|---|---|
| Fishy odour | trimethylamine |
| Rotting animal and | Tyramine |
| vegetable matter | |

Tyramine is formed by bacterial action on tyrosine.

Any aldehyde that can be immobilised in a film can be used in the sensor film. Butanal, pentanal, hexanal, gluteraldehyde and trans-2-hexenal are some of the preferred aldehydes.

Similar procedures to preparing the amine containing sensor film may be used.

It is possible to have a sensor element which can detect both aldehydes and amines as long as the amine containing film is physically separated and non reacting with the aldehyde containing sensor film. The two separate regions are separately analysed for fluorescence. This means that the same sensor element can be used in a variety of applications.

From the above it can be seen that the present invention provides a unique odour sensor of high sensitivity that is able to detect odours below the human threshold of smell and more consistently.

1. A sensor for detecting vapour phase molecules which includes
a) a sensor element consisting of an amine or aldehyde dispersed in a polymeric film
b) a light source for radiating the sensor element
c) a light detector for receiving fluorescence from said sensor element
d) a programmable means for analysing the fluorescence to determine the type and concentration of the vapour phase molecule.

2. A sensor as claimed in claim 1 wherein the light source is an ultraviolet light source.

3. A sensor as claimed in claim 1 wherein the light detector is a camera.

4. A sensor element for detecting vapour phase aldehyde molecules consisting of a polymeric film containing an amine.

5. A sensor element as claimed in claim 4 wherein the amine is tyramine

6. A method of assessing rancidity in foodstuffs which includes the steps of placing a sensor element as claimed in claim 4 or 5 in the presence of the food, exposing the sensor element to a UV light source and measuring the fluorescence emitted to determine the degree of rancidity

7. A sensor element for detecting vapour phase amine molecules consisting of a polymeric film containing an aldehyde.

8. A sensor element as claimed in claim 6 wherein the aldehyde is selected from butenal, pentanal and hexanal.
